(19) United States
(12) Patent Application Publication
(10) Pub. No.: US 2025/0377255 A1
(43) Pub. Date: Dec. 11, 2025

(54) SYSTEMS, APPARATUSES, AND METHODS FOR TESTING CRYOGENIC COUPLINGS

(71) Applicant: The Boeing Company, Arlington, VA (US)

(72) Inventor: Kevin A. Nemeth, Redondo Beach, CA (US)

(73) Assignee: The Boeing Company, Arlington, VA (US)

(21) Appl. No.: 18/734,174

(22) Filed: Jun. 5, 2024

(51) Int. Cl. G01M 3/02; F16L 37/248

(52) U.S. Cl. CPC G01M 3/02; F16L 37/248; F16L 2201/30; F16L 2201/40

(57) ABSTRACT

An apparatus for testing a cryogenic coupling includes a frame, a first clamp plate, and a second clamp plate. The first clamp plate is coupled to the frame and is configured to contact a first end of the cryogenic coupling. The second clamp plate is coupled to the frame and is configured to contact a second end of the cryogenic coupling. At least one of the first clamp plate and the second clamp plate is movable along the frame relative to one another such that the cryogenic coupling is clamped between the first clamp plate and the second clamp plate.

### FIELD

The present disclosure relates generally to cryogenic couplings and, more particularly, to systems, apparatuses, and methods for pressure and leak testing of cryogenic bayonet couplings.

### BACKGROUND

A cryogenic bayonet coupling is a connection assembly used for safe and efficient transfer of cryogenic fluid, such as with vacuum insulated piping (VIP) systems. The cryogenic bayonet coupling includes male and female connectors to create separate vacuum insulated spaces on either side of the connection. Conventional techniques for pressure and leak testing of a cryogenic bayonet coupling requires physical modification of the cryogenic bayonet coupling. For example, testing typically involves welding a cap on ends of the connectors to seal the interior for internal pressurization and leak testing. Following the test, the cap must then be cut off, and the ends of the connector must be refinished to smooth the cap interface. These welding, cutting, and machining operations can produce undesirable debris and heat, which can change the end-use configuration of the connector. Accordingly, those skilled in the art continue with research and development efforts in pressure and leak testing of cryogenic bayonet couplings.

### SUMMARY

Disclosed are examples of an apparatus for testing a cryogenic coupling, a system for testing a cryogenic coupling, and a method for testing a cryogenic coupling. The following is a non-exhaustive list of examples, which may or may not be claimed, of the subject matter according to the present disclosure.

In an example, the disclosed apparatus includes a frame, a first clamp plate, and a second clamp plate. The first clamp plate is coupled to the frame and is configured to contact a first end of the cryogenic coupling. The second clamp plate is coupled to the frame and is configured to contact a second end of the cryogenic coupling. At least one of the first clamp plate and the second clamp plate is movable along the frame relative to one another such that the cryogenic coupling is clamped between the first clamp plate and the second clamp plate.

In an example, the disclosed system includes a frame, a first clamp plate, a second clamp plate, a first seal, a second seal, at least one of a first pressure fitting and a second pressure fitting, and a pressure source. The first clamp plate is coupled to the frame and is configured to contact a first end of the cryogenic coupling. The second clamp plate is coupled to the frame and configured to contact a second end of the cryogenic coupling. The first seal is configured to create a hermetic seal between the first clamp plate and the first end of the cryogenic coupling. The second seal 114 is configured to create a hermetic seal between the second clamp plate and the second end of the cryogenic coupling. The first pressure fitting is configured to be coupled to the first end of the cryogenic coupling through the first clamp plate. The second pressure fitting is configured to be coupled to the second end of the cryogenic coupling through the second clamp plate. The pressure source is coupled to at least the one of the first pressure fitting and the second pressure fitting. At least one of the first clamp plate and the second clamp plate is movable along the frame relative to one another such that the cryogenic coupling is clamped between the first clamp plate and the second clamp plate.

In an example, the disclosed method includes steps of: (1) clamping a cryogenic coupling between a first clamp plate and a second clamp plate; (2) sealing a first end of the cryogenic coupling with the first clamp plate; (3) sealing a second end of the cryogenic coupling with the second clamp plate; and (4) pressurizing an interior of the cryogenic coupling.

Other examples of the apparatus, the system, and the method will become apparent from the following detailed description, the accompanying drawings, and the appended claims.

### BRIEF DESCRIPTION OF THE DRAWINGS

FIG. 1 is a schematic block diagram of an example of a testing apparatus;

FIG. 2 is a flow diagram of an example of a testing method;

FIG. 3 is a schematic, perspective view of an example of the apparatus;

FIG. 4 is a schematic, perspective view of an example of the apparatus;

FIG. 5 is a schematic, perspective, exploded view of an example of the apparatus;

FIG. 6 is a schematic, perspective, exploded view of an example of a first clamp plate of the apparatus;

FIG. 7 is a schematic, perspective view of an example of the first clamp plate;

FIG. 8 is a schematic, perspective view of an example of the first clamp plate;

FIG. 9 is a schematic, perspective view of an example of a second clamp plate of the apparatus;

FIG. 10 is a schematic, opposing perspective view of the example of the second clamp plate shown in FIG. 9;

FIG. 11 is a schematic, sectional view of an example of the second clamp plate;

FIG. 12 is a schematic, sectional view of an example of a portion of the second clamp plate shown in FIG. 11;

FIG. 13 is a schematic, perspective view of an example of the second clamp plate;

FIG. 14 is a schematic, opposing perspective view of the example of the second clamp plate shown in FIG. 13;

FIG. 15 is a schematic, sectional view of an example of a portion of the second clamp plate;

FIG. 16 is a schematic, perspective view of an example of the second clamp plate;

FIG. 17 is a schematic, opposing perspective view of the example of the second clamp plate shown in FIG. 16; and

FIG. 18 is a schematic, sectional view of an example of a portion of the second clamp plate shown in FIG. 16.

### DETAILED DESCRIPTION

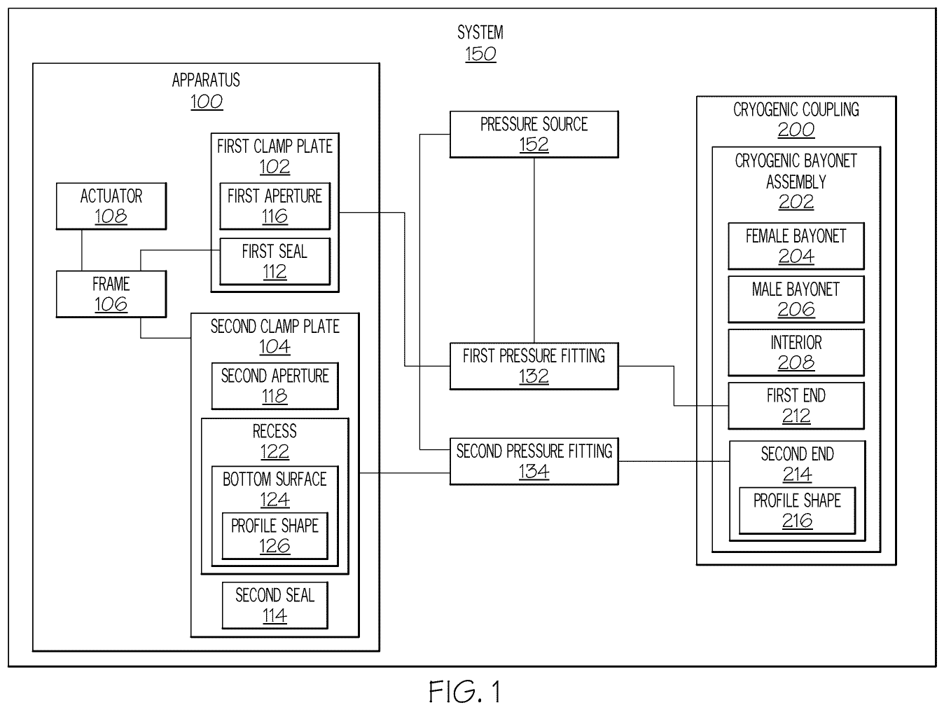

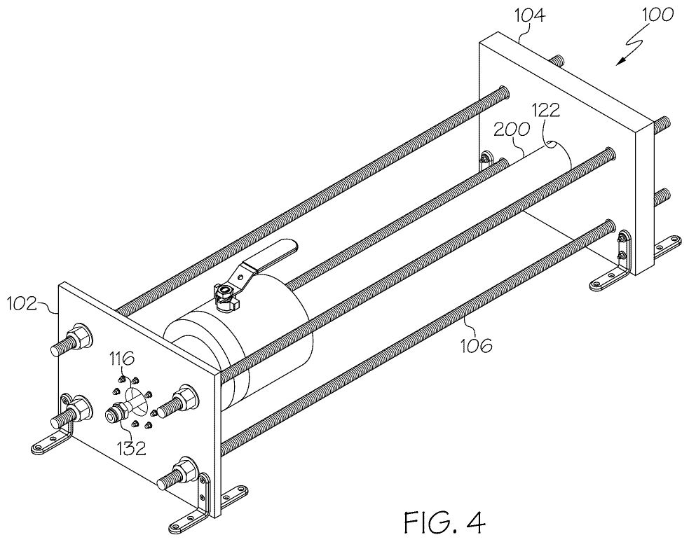

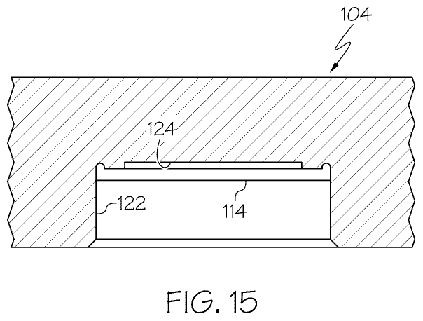

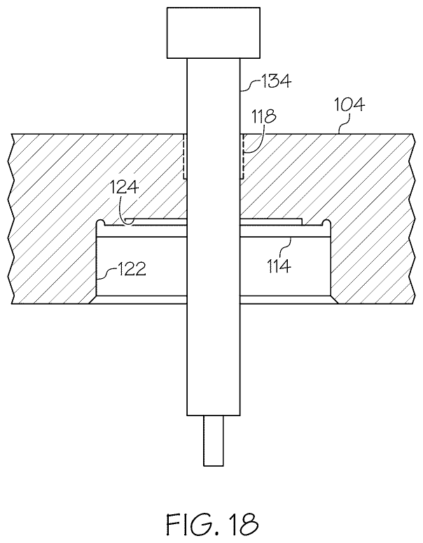

Referring generally to FIGS. 1-18, by way of examples, the present disclosure is directed to an apparatus 100, a system 150, and a method 1000 for testing a cryogenic coupling 200. Examples of the apparatus 100, system 150, and method 1000 improve upon techniques for pressure and leak testing cryogenic couplings by eliminating the need for physical modifications to the cryogenic coupling due to conventional processes of welding caps and/or fittings to ends of the cryogenic coupling, cutting off the caps and/or fittings, and post-processing the ends of the cryogenic coupling. Generally, examples of the apparatus 100, system 150, and method 1000 utilize a unique test fixture that enables the cryogenic coupling 200 to be sealed, internally pressurized, and tested without physically modifying the ends of the cryogenic coupling 200 to facilitate the test.

Throughout the present disclosure, the cryogenic coupling 200 refers to or includes any suitable cryogenic bayonet coupling, also known as a Johnston coupling, which may be used as a connection for vacuum insulated piping (VIP) systems. In various examples, the cryogenic coupling 200 includes a male connector and a female connector that create separate vacuum insulated spaces on either side of the connection. The male bayonet connector's outer tube fits inside the female bayonet connector's inner tube, thereby forming a long conduction path between the two lines. This design creates a low heat leak connection and can be installed without welding or special training. In various examples, the cryogenic bayonet coupling provides for separate isolation vacuum spaces on either side of the connection. Each side of the bayonet is a pair of concentric tubes that form a vacuum insulated pipe. The cryogenic bayonet coupling is designed such that the outer tube of the male bayonet fits closely inside the inner tube of the female bayonet. The bayonet is relatively long to provide for thermal isolation between the room temperature end of the joint and the cold piping. When one bayonet is inserted in the other and a cryogenic fluid flows inside the inner tube, a static column of vapor fills the region between the two bayonets. The sizes of the bayonets are selected for a close sliding fit to keep the dimensions of this vapor column to a minimum and reduce heat loss due to convection in the vapor column. In some examples, an O-ring at the coupling flange seals the internal volume.

In some examples, the cryogenic coupling 200 refers to or includes the female bayonet connector (e.g., female bayonet 204). In some examples, the cryogenic coupling 200 refers to or includes the male bayonet connector (e.g., male bayonet 206). In some examples, the cryogenic coupling 200 refers to or includes the entire cryogenic bayonet coupling (e.g., cryogenic bayonet assembly 202), including both the female bayonet connector (e.g., female bayonet 204) and the male bayonet connector (e.g., male bayonet 206). In the various illustrative examples, the cryogenic coupling 200 includes a first end 212 and a second end 214, which is opposite the first end 212 along a central longitudinal axis of the cryogenic coupling 200. Each one of the first end 212 and the second end 214 includes an opening (e.g., a first opening or port at the first end 212 and a second opening or port at the second end 214) that permits a cryogenic fluid to pass into and/or through an interior 208 (e.g., internal volume) of the cryogenic coupling 200.

Referring now to FIGS. 1 and 3-18, the following are examples of the apparatus 100, according to the present disclosure. The apparatus 100 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIG. 1, as will be described in more detail herein, in various examples, the apparatus 100 includes a number of components, including one or more of a frame 106, a first clamp plate 102, a second clamp plate 104, an actuator 108, a first seal 112, a second seal 114, a first aperture 116, a second aperture 118, a recess 122, a bottom surface 124, and a profile shape 126.

Referring to FIGS. 1 and 3-5, in one or more examples, the apparatus 100 includes the frame 106, the first clamp plate 102, and the second clamp plate 104. The frame 106 is configured to support the first clamp plate 102 and the second clamp plate 104. The first clamp plate 102 is coupled to the frame 106. The first clamp plate 102 is configured to contact the first end 212 of the cryogenic coupling 200. The second clamp plate 104 is coupled to the frame 106. The second clamp plate 104 is configured to contact the second end 214 of the cryogenic coupling 200. At least one of the first clamp plate 102 and the second clamp plate 104 is movable along the frame 106 relative to one another such that the cryogenic coupling 200 is clamped between the first clamp plate 102 and the second clamp plate 104.

Selective movement of the first clamp plate 102 and/or the second clamp plate 104 relative to the frame 106 enables first clamp plate 102 and the second clamp plate 104 to cover and seal the openings in the ends of the cryogenic coupling 200 and, thereby, enclose and seal the hollow interior (e.g., internal volume) of the cryogenic coupling 200 for testing. With the first clamp plate 102 and the second clamp plate 104 properly positioned relative to the cryogenic coupling 200 and the cryogenic coupling 200 sealed, the internal volume of the cryogenic coupling 200 can be pressurized and leaks can be detected.

In one or more examples, the first clamp plate 102 is configured to move along or relative to the frame 106 such that the first clamp plate 102 is selectively positioned relative to the cryogenic coupling 200 to engage the first end 212 of the cryogenic coupling 200. In one or more examples, the second clamp plate 104 is configured to move along or relative to the frame 106 such that the second clamp plate 104 is selectively positioned relative to the cryogenic coupling 200 to engage the second end 214 of the cryogenic coupling 200.

The frame 106 can have any one of various different structural configurations configured to support and enable movement of the first clamp plate 102 and the second clamp plate 104. In one or more examples, the frame 106 includes one or more rails upon which the first clamp plate 102 and the second clamp plate 104 are mounted and along which at least one of the first clamp plate 102 and/or the second clamp plate 104 is movable. In one or more examples, the frame 106 includes one or more bars upon which the first clamp plate 102 and the second clamp plate 104 are mounted and along which at least one of the first clamp plate 102 and/or the second clamp plate 104 is slidable. In one or more examples, the frame 106 includes one or more screws upon which the first clamp plate 102 and the second clamp plate 104 are mounted and along which at least one of the first clamp plate 102 and/or the second clamp plate 104 is driven.

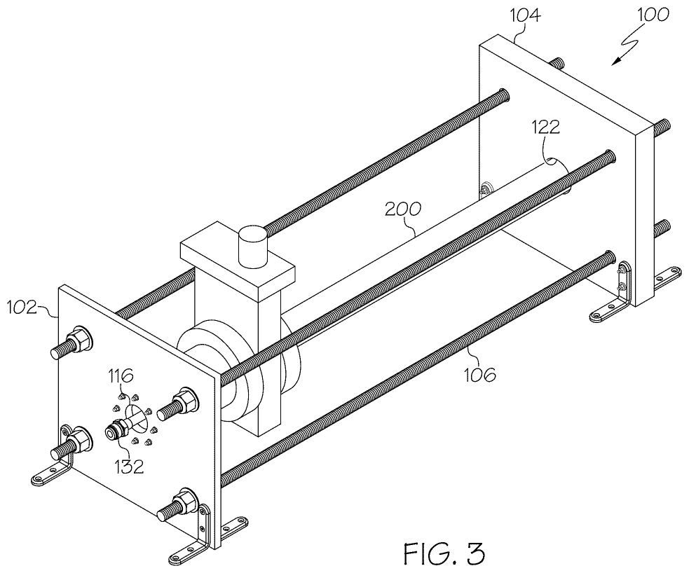

In one or more examples, as illustrated in FIGS. 3-5, the first clamp plate 102 and the second clamp plate 104 are designed and fabricated for contact and engagement with respective ends of a specific type (e.g., size, shape, model, etc.) of the cryogenic coupling 200. In one or more examples, the first clamp plate 102 and/or the second clamp plate 104 are designed and fabricated for sealing engagement with respective ends of a specific type (e.g., size, shape, model, etc.) of the cryogenic coupling 200. Similarly, the frame 106 is sized to accommodate the specific type (e.g., size, shape, model, etc.) of the cryogenic coupling 200 such that the first clamp plate 102 and/or the second clamp plate 104 can be properly positioned relative to the ends of the cryogenic coupling 200.

In one or more examples, the first clamp plate 102 and the second clamp plate 104 contact a respective one of the first end 212 and the second end 214. In these examples, the first clamp plate 102 and the second clamp plate 104 are utilized to apply an axial clamping force to the cryogenic coupling 200 and to support the cryogenic coupling 200 during the testing operation. In one or more examples, the first clamp plate 102 is configured to seal the first opening or port of the first end 212 of the cryogenic coupling 200 when the first clamp plate 102 is positioned in engaging contact with the first end 212. In one or more examples, the second clamp plate 104 is configured to seal the second opening or port of the second end 214 of the cryogenic coupling 200 when the second clamp plate 104 is positioned in engaging contact with the second end 214.

In one or more examples, the opening of the first end 212 and/or the second end 214 of the cryogenic coupling 200 is capped using a pressure fitting (e.g., a first pressure fitting 132 and/or a second pressure fitting 134). In one or more examples, the pressure fitting is coupled to or is situated in fluid communication with the interior 208 through a respective one of the ends of the cryogenic coupling 200 and enables the interior 208 of the cryogenic coupling 200 to be pressurized through one of the ends during the testing operation. In one or more examples, the pressure fittings are coupled to or are situated in fluid communication with the interior 208 through both of the ends of the cryogenic coupling 200 and enable the interior 208 of the cryogenic coupling 200 to be pressurized through both ends during the testing operation.

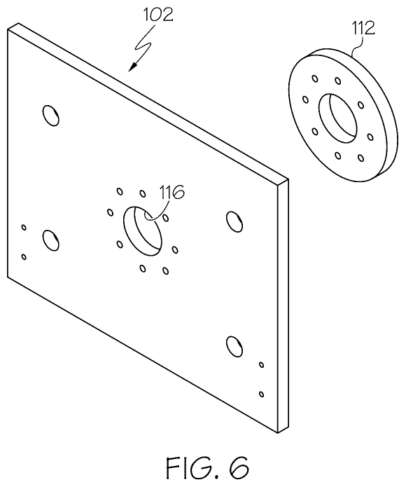

In one or more examples, as illustrated in FIG. 6, the first clamp plate 102 is configured to receive or accommodate the first pressure fitting 132. In these examples, the first pressure fitting 132 is coupled to the first end 212 and is in fluid communication with the interior 208 through the first opening in the first end 212. In these examples, the first clamp plate 102 supports the first end 212 of the cryogenic coupling 200. In some of these examples, the first clamp plate 102 also seals the first end 212 of the cryogenic coupling 200.

In one or more examples, as illustrated in FIG. 8, the first pressure fitting 132 is incorporated within or is coupled to the first clamp plate 102. In these examples, the first pressure fitting 132 is in fluid communication with the interior 208 through the first opening in the first end 212 when the first clamp plate 102 is positioned in engaging contact with the first end 212. In these examples, the first clamp plate 102 also seals the first end 212 of the cryogenic coupling 200.

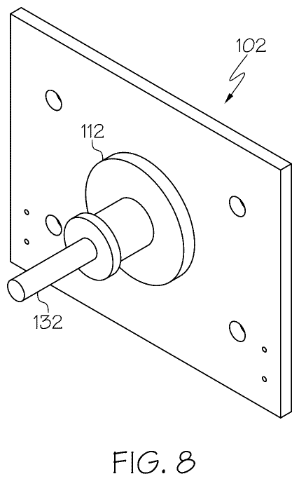

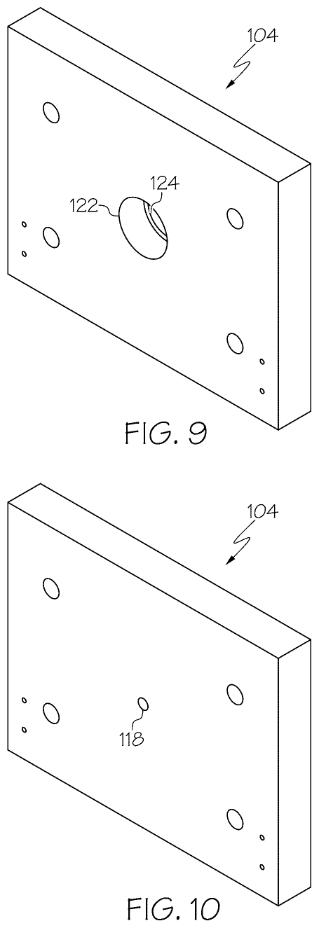

In one or more examples, as illustrated in FIG. 9-12, the second clamp plate 104 is configured to receive or accommodate the second pressure fitting 134. In these examples, the second pressure fitting 134 is coupled to the second end 214 and is in fluid communication with the interior 208 through the second opening in the second end 214. In these examples, the second clamp plate 104 supports the second end 214 of the cryogenic coupling 200. In some of these examples, the second clamp plate 104 also seals the second end 214 of the cryogenic coupling 200.

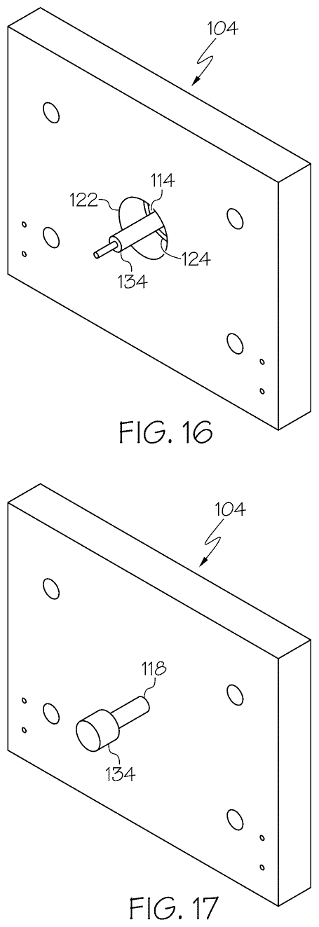

In one or more examples, as illustrated in FIG. 16-18, the second pressure fitting 134 is incorporated within or is coupled to the second clamp plate 104. In these examples, the second pressure fitting 134 is in fluid communication with the interior 208 through the second opening in the second end 214 when the second clamp plate 104 is positioned in engaging contact with the second end 214. In these examples, the second clamp plate 104 also seals the second end 214 of the cryogenic coupling 200.

Referring to FIGS. 1 and 6-8, in one or more examples, the apparatus 100 includes the first seal 112. In one or more examples, the first seal 112 is coupled to the first clamp plate 102. The first seal 112 is configured to create a hermetic seal between the first clamp plate 102 and the first end 212 of the cryogenic coupling 200.

In various examples, the first seal 112 can include or be made of any suitable material capable of creating or forming the hermetic seal between the first clamp plate 102 and the first end 212 of the cryogenic coupling 200 when the first clamp plate 102 is moved into engagement with the first end 212 of the cryogenic coupling 200. In one or more examples, the first seal 112 includes or is made of polytetrafluoroethylene (PTFE), such as Teflon. In one or more examples, the first seal 112 includes or is made of a nitrile rubber, such as Buna-N rubber, or other suitable synthetic rubber material.

Referring to FIGS. 1, 3-6 and 8, in one or more examples, the first clamp plate 102 includes the first aperture 116. The first aperture 116 is configured to receive the first pressure fitting 132. In one or more examples, the first pressure fitting 132 is coupled to the first end 212 of the cryogenic coupling 200. In these examples, a portion of the first pressure fitting 132 extends through the first aperture 116 when the first clamp plate 102 is moved into engagement with the first end 212 of the cryogenic coupling 200. In one or more examples, the first clamp plate 102 includes the first pressure fitting 132. In these examples, the first pressure fitting 132 is configured to be coupled to and situated in fluid communication with the first end 212 of the cryogenic coupling 200 when the first clamp plate 102 is moved into engagement with the first end 212 of the cryogenic coupling 200.

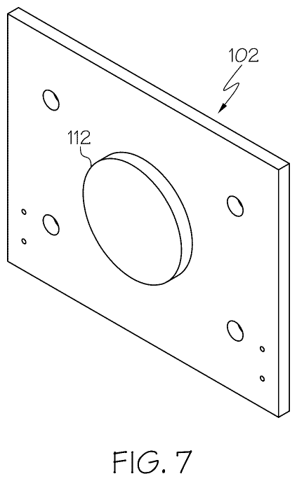

In one or more examples, as illustrated in FIGS. 6 and 8, the first seal 112 is annular in shape and includes a central aperture that is configured to align with the first aperture 116 of the first clamp plate 102. In these examples, the first seal 112 is configured to receive or accommodate the first pressure fitting 132. In one or more examples, as illustrated in FIG. 7, the first seal 112 is disk-shaped. In these examples, the first seal 112 is configured to contact the first end 212 of the cryogenic coupling 200 to support the cryogenic coupling 200 during clamping and testing. In some of these examples, the first seal 112 is also configured to hermetically seal the first opening the first end 212.

Referring to FIGS. 1, 5 and 9-18, in one or more examples, the apparatus 100 includes the second seal 114. In one or more examples, the second seal 114 is coupled to the second clamp plate 104. The second seal 114 is configured to create a hermetic seal between the second clamp plate 104 and the second end 214 of the cryogenic coupling 200.

In various examples, the second seal 114 can include or be made of any suitable material capable of creating or forming the hermetic seal between the second clamp plate 104 and the second end 214 of the cryogenic coupling 200 when the second clamp plate 104 is moved into engagement with the second end 214 of the cryogenic coupling 200. In one or more examples, the second seal 114 includes or is made of polytetrafluoroethylene (PTFE), such as Teflon. In one or more examples, the second seal 114 includes or is made of a nitrile rubber, such as Buna-N rubber, or other suitable synthetic rubber material.

Referring to FIGS. 1, 5, 9-12 and 16-18, in one or more examples, the second clamp plate 104 includes the second aperture 118. The second aperture 118 is configured to receive the second pressure fitting 134. In one or more examples, the second pressure fitting 134 is coupled to the second end 214 of the cryogenic coupling 200. In these examples, a portion of the second pressure fitting 134 extends through the second aperture 118 when the second clamp plate 104 is moved into engagement with the second end 214 of the cryogenic coupling 200. In one or more examples, the second clamp plate 104 includes the second pressure fitting 134. In these examples, the second pressure fitting 134 is configured to be coupled to and situated in fluid communication with the second end 214 of the cryogenic coupling 200 when the second clamp plate 104 is moved into engagement with the second end 214 of the cryogenic coupling 200.

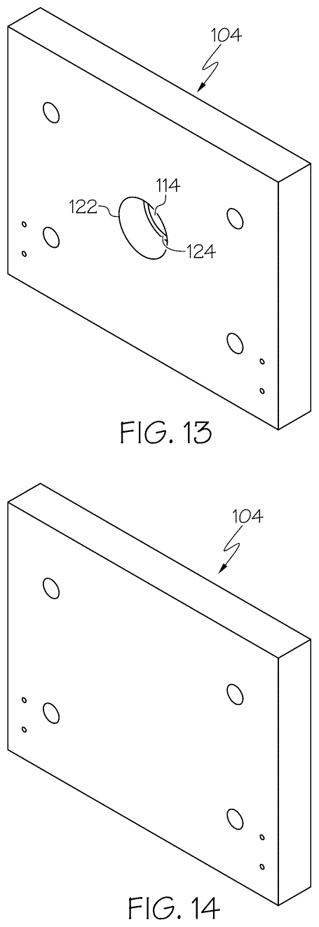

In one or more examples, as illustrated in FIGS. 9-12 and 16-18, the second seal 114 is annular in shape and includes a central aperture that is configured to align with the second aperture 118 of the second clamp plate 104. In these examples, the second seal 114 is configured to receive or accommodate the second pressure fitting 134. In one or more examples, as illustrated in FIGS. 13-15, the second seal 114 is disk-shaped. In these examples, the second seal 114 is configured to contact the second end 214 of the cryogenic coupling 200 to support the cryogenic coupling 200 during clamping and testing. In some of these examples, the second seal 114 is also configured to hermetically seal the second opening the second end 214.

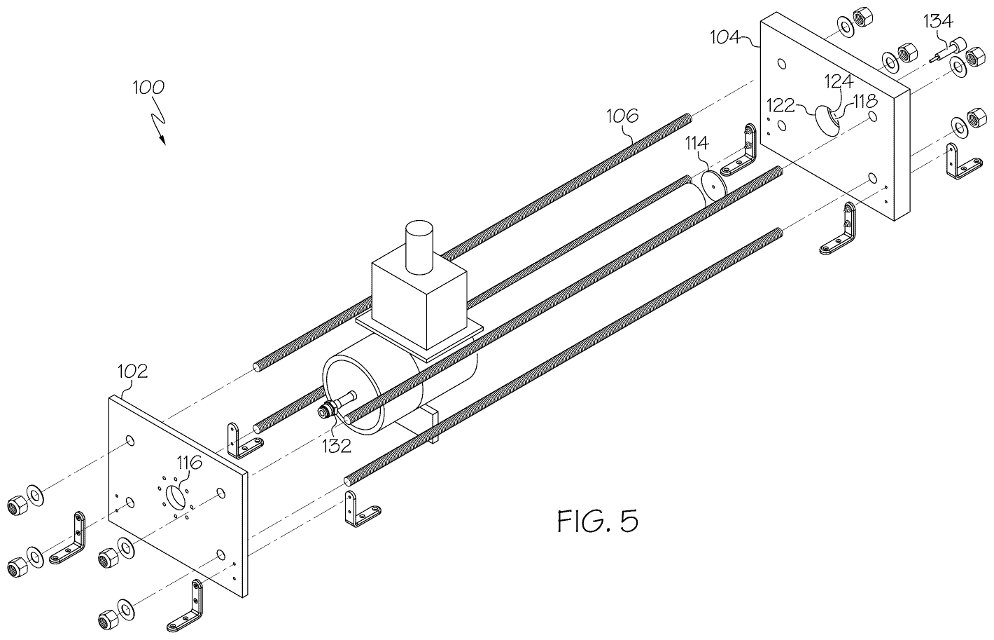

Referring to FIGS. 5, 9, 11, 12, 13, 15, 16 and 18, in one or more examples, the second clamp plate 104 includes the recess 122. The recess 122 is configured to receive the second end 214 of the cryogenic coupling 200. Generally, the recess 122 has a geometry (e.g., size and shape) that matches and that is in relatively close tolerance with the geometry of the second end 214 of the cryogenic coupling 200. In one or more examples, the second seal 114 is situated within the recess 122. In these examples, the second seal 114 is configured to create a hermetic seal between the second clamp plate 104 and the second end 214 of the cryogenic coupling 200 when the second end 214 is inserted within the recess 122 and contacts the second clamp plate 104.

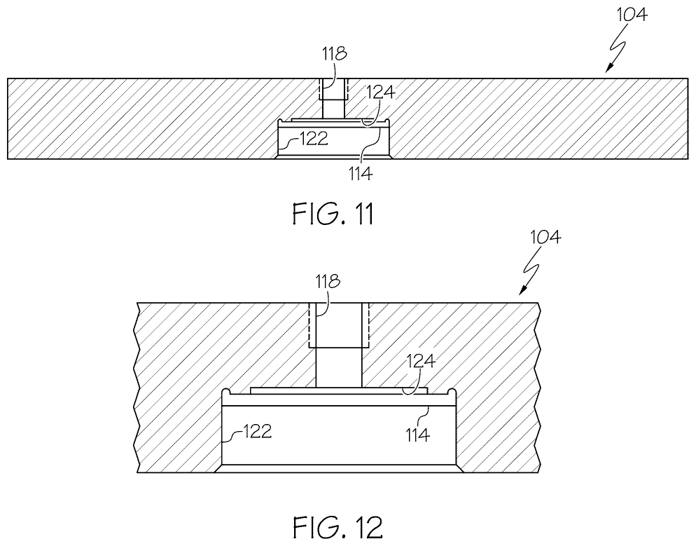

As best illustrated in FIGS. 11, 12, 15 and 18, in one or more examples, the second clamp plate 104 includes or forms the bottom surface 124 of the recess 122. The bottom surface 124 includes the profile shape 126. The profile shape 126 of the bottom surface 124 substantially matches a profile shape 216 of the second end 214 of the cryogenic coupling 200. In these examples, the bottom surface 124 is configured to contact the second end 214 of the cryogenic coupling 200 when the second end 214 is inserted within the recess 122. The profile shape 126 of the bottom surface 124 being complementary to the profile shape 216 of the second end 214 facilitates a tight seal between the bottom surface 124 and the second end 214 and reduces the chance of damaging the second end 214 during the clamp up operation.

Referring still to FIGS. 11, 12, 15 and 18, in one or more examples, the second seal 114 is situated within the recess 122. In these examples, the second seal 114 is configured to create a hermetic seal between the bottom surface 124 and the second end 214 of the cryogenic coupling 200.

While not explicitly illustrated, in some examples, the first clamp plate 102 includes a recess (a first instance of the recess 122). This recess of the first clamp plate 102 is configured to receive the first end 212 of the cryogenic coupling 200. Generally, the recess has a geometry (e.g., size and shape) that matches and that is in relatively close tolerance with the geometry of the first end 212 of the cryogenic coupling 200. In some of these examples, the first seal 112 is situated within the recess of the first clamp plate 102. In these examples, the first seal 112 is configured to create a hermetic seal between the first clamp plate 102 and the first end 212 of the cryogenic coupling 200 when the first end 212 is inserted within the recess and contacts the first clamp plate 102.

Referring to FIG. 1, in one or more examples, the apparatus 100 includes the actuator 108. The actuator 108 is configured to drive movement of at least one of the first clamp plate 102 and the second clamp plate 104 along the frame 106. The actuator 108 can include any suitable device or mechanism configured to generate motion and includes various components common to such devices or mechanisms. The actuator 108 can be a linear actuator or a rotary actuator. The actuator 108 can be a mechanical actuator, a pneumatic actuator, or a hydraulic actuator.

Referring now to FIGS. 1 and 3-18, the following are examples of the system 150, according to the present disclosure. The system 150 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring again to FIG. 1, as will be described in more detail herein, in various examples, the system 150 includes a number of components, including one or more of the frame 106, the first clamp plate 102, the second clamp plate 104, the actuator 108, the first seal 112, the second seal 114, the first pressure fitting 132, the second pressure fitting 134, and a pressure source 152.

Referring to FIGS. 1 and 3-18, in one or more examples, the system 150 includes the frame 106, the first clamp plate 102, and the second clamp plate 104. In one or more examples, the system 150 also includes the first seal 112 and the second seal 114. The first clamp plate 102 is coupled to the frame 106 and is configured to contact the first end 212 of the cryogenic coupling 200. The second clamp plate 104 is coupled to the frame 106 and is configured to contact the second end 214 of the cryogenic coupling 200. The first seal 112 is configured to create a hermetic seal between the first clamp plate 102 and the first end 212 of the cryogenic coupling 200. The second seal 114 is configured to create a hermetic seal between the second clamp plate 104 and the second end 214 of the cryogenic coupling 200. At least one of the first clamp plate 102 and the second clamp plate 104 is movable along the frame 106 relative to one another such that the cryogenic coupling 200 is clamped between the first clamp plate 102 and the second clamp plate 104.

In one or more examples, the system 150 includes at least one of the first pressure fitting 132 and/or the second pressure fitting 134. The first pressure fitting 132 is configured to be coupled to the first end 212 of the cryogenic coupling 200 through the first clamp plate 102. The second pressure fitting 134 is configured to be coupled to the second end 214 of the cryogenic coupling 200 through the second clamp plate 104.

In one or more examples, the system 150 includes the pressure source 152. The pressure source 152 is coupled to and is in fluid communication with at least the one of the first pressure fitting 132 and/or the second pressure fitting 134. The pressure source 152 introduces a pressurized fluid within the interior 208 of the interior 208 through at least one of the first end 212 and/or the second end 214 via a respective one of the first pressure fitting 132 and/or the second pressure fitting 134. In these examples, the first pressure fitting 132 and/or the second pressure fitting 134 facilitate connection and fluid communication of the pressure source 152 and the cryogenic coupling 200.

While not explicitly described herein, in other examples, the system 150 includes any one or combination of components, elements, and/or features described herein and/or illustrated in connection with one or more examples of the apparatus 100.

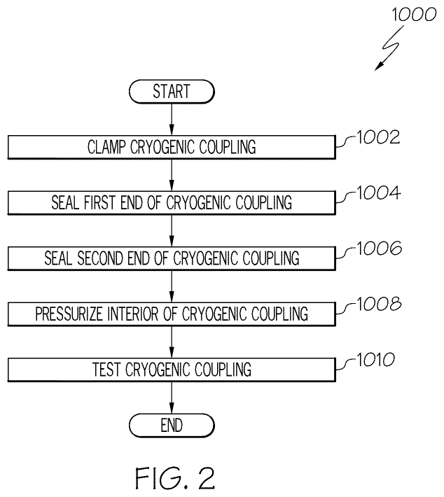

Referring now to FIG. 2, the following are examples of the method 1000, according to the present disclosure. The method 1000 includes a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

Referring generally to FIGS. 1 and 3-18 and particularly to FIG. 2, in one or more examples, the method 1000 is implemented using the apparatus 100. In one or more examples, the method 1000 is implemented using the system 150.

In one or more examples, the method 1000 includes a step of clamping 1002 the cryogenic coupling 200 between the first clamp plate 102 and the second clamp plate 104. In one or more examples, the cryogenic coupling 200 is positioned between the first clamp plate 102 and the second clamp plate 104. At least one of the first clamp plate 102 and/or the second clamp plate 104 is moved along the frame 106 relative to the cryogenic coupling 200 such that the first clamp plate 102 is in engaging contact with the first end 212 of the cryogenic coupling 200 and the second clamp plate 104 is in engaging contact with the second end 214 of the cryogenic coupling 200.

In one or more examples, the method 1000 includes a step of sealing 1004 the first end 212 of the cryogenic coupling 200. In one or more examples, the first end 212 is sealed with the first clamp plate 102. In one or more examples, the first end 212 is sealed with the first seal 112. In one or more examples, according to the method 1000, the step of sealing 1004 the first end 212 of the cryogenic coupling 200 includes a step of creating a hermetic seal between the first clamp plate 102 and the first end 212 using the first seal 112.

In one or more examples, the method 1000 includes a step of sealing 1006 the second end 214 of the cryogenic coupling 200. In one or more examples, the second end 214 is sealed with the second clamp plate 104. In one or more examples, the second end 214 is sealed with the second seal 114. In one or more examples, according to the method 1000, the step of sealing 1006 the second end 214 of the cryogenic coupling 200 includes a step of creating a hermetic seal between the second clamp plate 104 and the second end 214 using the second seal 114.

In one or more examples, the method 1000 includes a step of pressurizing 1008 the interior 208 of the cryogenic coupling 200. In these examples, the interior 208 is pressurized by introducing or transferring a pressurized fluid from the pressure source 152 to the interior 208 of the cryogenic coupling 200 through at least one of the first end 212 and/or the second end 214.

In one or more examples, according to the method 1000, the step of pressuring 1008 the interior 208 includes a step of transferring a pressurized fluid to the interior 208 from or through the first end 212 of the cryogenic coupling 200. In these examples, the first clamp plate 102 seals the first end 212 of the cryogenic coupling 200. The pressure source 152 is coupled to and is in fluid communication with the first pressure fitting 132. The first clamp plate 102 includes or accommodates the first pressure fitting 132. The first pressure fitting 132 is coupled to first opening of the first end 212 and is in fluid communication with the interior 208 of the cryogenic coupling 200.

In one or more examples, according to the method 1000, the step of pressuring 1008 the interior 208 includes a step of transferring a pressurized fluid to the interior 208 from or through the second end 214 of the cryogenic coupling 200. In these examples, the second clamp plate 104 seals the second end 214 of the cryogenic coupling 200. The pressure source 152 is coupled to and is in fluid communication with the second pressure fitting 134. The second clamp plate 104 includes or accommodates the second pressure fitting 134. The second pressure fitting 134 is coupled to second opening of the second end 214 and is in fluid communication with the interior 208 of the cryogenic coupling 200.

In one or more examples, according to the method 1000, the step of pressuring 1008 the interior 208 includes a step of transferring a pressurized fluid to the interior 208 from or through the first end 212 and from or through the second end 214 of the cryogenic coupling 200. In these examples, the first clamp plate 102 seals the first end 212 and the second clamp plate 104 seals the second end 214 of the cryogenic coupling 200. The pressure source 152 is coupled to and is in fluid communication with the first pressure fitting 132 and the second pressure fitting 134. The first clamp plate 102 includes or accommodates the first pressure fitting 132. The second clamp plate 104 includes or accommodates the second pressure fitting 134. The first pressure fitting 132 is coupled to first opening of the first end 212 and is in fluid communication with the interior 208 of the cryogenic coupling 200. The second pressure fitting 134 is coupled to second opening of the second end 214 and is in fluid communication with the interior 208 of the cryogenic coupling 200.

In one or more examples, the method 1000 includes a step of testing 1010 the cryogenic coupling 200. The testing step is performed while and/or after the pressurizing step.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1 and 3-18, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1 and 3-18, referred to above, need be included in every example and not all elements, features, and/or components described herein are necessarily depicted in each illustrative example. Accordingly, some of the elements, features, and/or components described and illustrated in FIGS. 1 and 3-18 may be combined in various ways without the need to include other features described and illustrated in FIGS. 1 and 3-18, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1 and 3-18, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1 and 3-18, and such elements, features, and/or components may not be discussed in detail herein with reference to each of FIGS. 1 and 3-18. Similarly, all elements, features, and/or components may not be labeled in each of FIGS. 1 and 3-18, but reference numerals associated therewith may be utilized herein for consistency.

In FIG. 2, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIG. 2 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the apparatus 100, system 150, and the method 1000 have been shown and described, modifications may occur to those skilled in the art upon reading the specification. The present application includes such modifications and is limited only by the scope of the claims.

What is claimed is:

1. An apparatus for testing a cryogenic coupling, the apparatus comprising:
a frame,
a first clamp plate coupled to the frame and configured to contact a first end of the cryogenic coupling; and
a second clamp plate coupled to the frame and configured to contact a second end of the cryogenic coupling,
wherein at least one of the first clamp plate and the second clamp plate is movable along the frame relative to one another such that the cryogenic coupling is clamped between the first clamp plate and the second clamp plate.

2. The apparatus of claim 1, further comprising a first seal coupled to the first clamp plate and configured to create a hermetic seal between the first clamp plate and the first end of the cryogenic coupling.

3. The apparatus of claim 1, wherein the first clamp plate comprises a first aperture configured to receive a first pressure fitting coupled to the first end of the cryogenic coupling.

4. The apparatus of claim 1, wherein the first clamp plate comprises a first pressure fitting configured to be coupled to the first end of the cryogenic coupling.

5. The apparatus of claim 1, further comprising a second seal coupled to the second clamp plate and configured to create a hermetic seal between the second clamp plate and the second end of the cryogenic coupling.

6. The apparatus of claim 1, wherein the second clamp plate comprises a second aperture configured to receive a second pressure fitting coupled to the second end of the cryogenic coupling.

7. The apparatus of claim 1, wherein the second clamp plate comprises a second pressure fitting configured to be coupled to the second end of the cryogenic coupling.

8. The apparatus of claim 1, wherein the second clamp plate comprises a recess configured to receive the second end of the cryogenic coupling.

9. The apparatus of claim 8, further comprising a second seal situated within the recess and configured to create a hermetic seal between the second clamp plate and the second end of the cryogenic coupling.

10. The apparatus of claim 8, wherein:
the second clamp plate comprises a bottom surface of the recess; and
the bottom surface comprises a profile shape that substantially matches a profile shape of the second end of the cryogenic coupling.

11. The apparatus of claim 10, further comprising a second seal situated within the recess and configured to create a hermetic seal between the bottom surface and the second end of the cryogenic coupling.

12. The apparatus of claim 1, further comprising an actuator configured to drive movement of at least one of the first clamp plate and the second clamp plate along the frame.

13. The apparatus of claim 1, wherein:
the first clamp plate comprises:
a first aperture configured to receive a first pressure fitting coupled to the first end of the cryogenic coupling; and
a first seal configured to create a hermetic seal between the first clamp plate and the first end of the cryogenic coupling; and
the second clamp plate comprises:
a second aperture configured to receive a second pressure fitting coupled to the second end of the cryogenic coupling; and
a second seal configured to create a hermetic seal between the second clamp plate and the second end of the cryogenic coupling.

14. A system for testing a cryogenic coupling, the system comprising:
a frame,
a first clamp plate, coupled to the frame and configured to contact a first end of the cryogenic coupling;
a second clamp plate, coupled to the frame and configured to contact a second end of the cryogenic coupling;
a first seal, configured to create a hermetic seal between the first clamp plate and the first end of the cryogenic coupling; and
a second seal, configured to create a hermetic seal between the second clamp plate and the second end of the cryogenic coupling;
at least one of a first pressure fitting, configured to be coupled to the first end of the cryogenic coupling through the first clamp plate and a second pressure fitting, configured to be coupled to the second end of the cryogenic coupling through the second clamp plate; and
a pressure source coupled to at least the one of the first pressure fitting and the second pressure fitting,
wherein at least one of the first clamp plate and the second clamp plate is movable along the frame relative to one another such that the cryogenic coupling is clamped between the first clamp plate and the second clamp plate.

15. A method for testing a cryogenic coupling, the method comprising:
clamping the cryogenic coupling between a first clamp plate and a second clamp plate;
sealing a first end of the cryogenic coupling with the first clamp plate;
sealing a second end of the cryogenic coupling with the second clamp plate; and
pressurizing an interior of the cryogenic coupling.

16. The method of claim 15, wherein pressuring the interior comprises transferring a pressurized fluid to the interior from the first end of the cryogenic coupling.

17. The method of claim 15, wherein pressuring the interior comprises transferring a pressurized fluid to the interior from the second end of the cryogenic coupling.

18. The method of claim 15, wherein pressuring the interior comprises transferring a pressurized fluid to the interior from the first end and the second end of the cryogenic coupling.

19. The method of claim 15, wherein sealing the first end of the cryogenic coupling comprises creating a hermetic seal between the first clamp plate and the first end using a first seal.

20. The method of claim 15, wherein sealing the second end of the cryogenic coupling comprises creating a hermetic seal between the second clamp plate and the second end using a second seal.
